(19) United States
(12) Patent Application Publication
(10) Pub. No.: US 2002/0008473 A1
(43) Pub. Date: Jan. 24, 2002

(54) Plasma display panel

(75) Inventors: Yoshikazu Kanazawa, Kawasaki (JP); Shigeharu Asao, Kawasaki (JP)

Correspondence Address: STAAS & HALSEY LLP, 700 11TH STREET, NW, SUITE 500, WASHINGTON, DC, 20001, US

(73) Assignee: FUJITSU HITACHI PLASMA DISPLAY LIMITED, Kawasaki (JP)

(21) Appl. No.: 09/881,740

(22) Filed: Jun. 18, 2001

(30) Foreign Application Priority Data
Sep. 4, 2000 (JP) 2000-267272

(51) Int. Cl. H01J 17/49

(52) U.S. Cl. 313/582

(57) ABSTRACT

A plurality of discharge electrodes having transparent electrodes connected to bus electrodes are arranged on the inner side of a front substrate. Alternatively, discharge electrodes having transparent electrodes and capable of discharging between their respective neighboring electrodes on both sides are arranged on the inner side of the front substrate. The front substrate is provided on the side of the display surface where discharge-generated light radiates out to the exterior. Shielding parts for shielding incident light from the exterior are formed on the transparent electrodes, or along the front substrate. Accordingly, the shielding parts reduce the surface reflection to improve the bright room contrast ratio. Forming the shielding parts with the same material as that of the bus electrodes prevents fabrication processes from becoming complicated. The areas of the shielding parts can be varied with the luminescent colors of cells, to change the luminescent brightness by the cell.

### BACKGROUND OF THE INVENTION

1. Field of the Invention

The present invention relates to a plasma display panel, and more particularly to a technology for improving a bright room contrast ratio.

2. Description of the Related Art Plasma display panels (hereinafter, also referred to as PDPs) are display panels of self-luminous type, and are receiving attention as display panels that replace CRTs (Cathode Ray Tubes) by virtue of their high visibility and low profiles. A PDP is formed by filling discharge gas into a space of the order of 100 microns sandwiched between two glass substrates (a front substrate 26 and a rear substrate 34 in FIG. 2 to be described later) which are provided with electrodes. One of the glass substrate is coated with phosphors. Then, a voltage higher than or equal to a starting voltage is applied between the electrodes to cause a discharge, and the ultraviolet rays generated from the discharge make the phosphors excitation-luminous for pixel luminescence.

FIG. 1 shows an overview of one PDP 10 called a surface-discharge alternating-current type, among PDPs of this kind.

The PDP 10 is provided with a plurality of pairs of discharge electrodes 12 and 14 which extend in the horizontal direction of the diagram, and a plurality of address electrodes which are orthogonal to these discharge electrodes 12 and 14. The discharge electrodes 12 and 14 include transparent electrodes 18 and nontransparent bus electrodes 20 formed on these transparent electrodes 18. The transparent electrodes 18 are formed of tin oxide (SnO₂) or ITO (a transparent conductor consisting mainly of indium oxide), and have a relatively high resistance. The bus electrodes 20 are formed of metal such as copper. These bus electrodes 20 lower the resistances of the discharge electrodes 12 and 14.

Besides, a pair of discharge electrodes 12 and 14 form a display line L. A predetermined gap (non-display area) is arranged between neighboring display lines L so that the discharge electrodes 12 and 14 will not cause any accidental discharge across the two lines. In order to avoid a drop in bright room contrast ratio due to external light reflection, a black stripe 22 is formed in this gap.

Ribs 24 are formed between and along these address electrodes 16. Then, the regions surrounded by the black stripes 20 and the ribs 24 form cells C, or light emission units.

As shown in FIG. 2, the discharge electrodes 12, 14 and the black stripes 22 are formed on the side with the discharge space 28 of the front substrate 26 which lies on the observer side to make a display surface. A dielectric layer 30 for holding a wall charge and a protection layer 32 made of magnesium oxide (MgO) are formed over the discharge electrodes 12, 14 and the black stripes 22.

Meanwhile, as shown in FIG. 3, the address electrodes 16 and the ribs 24 are formed on the side with the discharge space 28 of the rear substrate 34. A dielectric layer 36 is formed over the address electrodes 16. The ribs 24 are formed on this dielectric layer 36. Phosphor layers R, G, and B are formed over the inclined planes of the ribs 24 and the dielectric layer 36 surrounded by the ribs 24. The phosphor layers R, G, and B respectively emit red light, green light, and blue light, by the incidence of discharge-generated ultraviolet rays. That is, in this example, a single pixel capable of full color display is composed of three cells.

In the above-described PDP, before pixel display, a reset pulse is applied to between the discharge electrodes 12 and 14 to initialize the cells (reset period). Then, address pulses are applied to address electrodes 16 that correspond to data to be displayed, thereby selecting cells C to emit light (address period). Then, sustain pulses are applied to between the discharge electrodes 12 and 14 over periods corresponding to the brightness gradations, to make a sustain discharge for the selected cells C (sustentation period). Ultraviolet rays generated from the sustain-discharge excite the phosphor layer R (or G, B) to emit light. Then, the light is transmitted through the transparent electrodes 18 and the front substrate 26 to radiate out to the exterior, thereby displaying an image.

FIG. 4 shows an overview of another PDP 38 disclosed in Japanese Patent No. 2801893 Gazette. This kind of PDP is referred to as ALIS (Alternate Lighting of Surfaces) technology.

The PDP 38 has a plurality of discharge electrodes 40 formed at regular intervals. Address electrodes 16 and ribs 24 are arranged as in FIG. 1. The black stripes 22 shown in FIG. 1 are not formed in this PDP 38. On this account, the discharge electrodes 40 except the ones on both ends can make a discharge with their respective adjacent discharge electrodes 40 on both sides. That is, cells C, or light emission units, are formed to overlap with each other along the address electrodes 16. Display lines L are also formed to overlap with each other. As a result, given an equal definition, the number of discharge electrodes becomes about half that in the PDP 10 of FIG. 1. The absence of non-luminescence regions allows an improvement in brightness if the panel sizes are identical.

FIG. 5 shows a cross section of the PDP 38 taken along an address signal 16, and luminescent intensities along the cross section.

In the luminescent intensity (1), the solid line indicates the intensity for situations where the display line L1 emits light, and the broken line indicates the intensity for situations where the display line L2 emits light. More specifically, the luminescent intensity on each line reaches the maximum in the middle of the neighboring discharge electrodes 40, and decreases with distance from the middle. The display lines L1 and L2 repeat alternate luminescence successively. Therefore, the actual intensity distribution, as shown in the luminescent intensity (2), is given by the sum of the solid line and the broken line in the luminescent intensity (1). Accordingly, the entire PDP 38 offers the maximum luminescent intensity in the very middles of the spaces between discharge electrodes 40.

FIG. 6 shows a cross section of the PDP 38 taken along a discharge electrode, and luminescent intensities along the cross section.

The solid line indicates the luminescent intensity for situations where the ribs 24 are formed of nontransparent material, and the broken line indicates the luminescent intensity for situations where the ribs 24 are formed of a transparent dielectric or the like. The luminescent intensities have three peaks. Of these, one lies in the portion where the address electrode 16 and the discharge electrode 40 face each other, while the other two fall on the inclined planes of the ribs 24. The facing portion of the address electrode 16 and the discharge electrode 40 is where the discharge becomes the most active; a large amount of ultraviolet rays occur for higher luminescent intensity. The inclined planes of the ribs 24 increase in radiation density as seen from the side of the front substrate 26. On the inclined planes, the substantial radiations from the phosphor layer R (or G, B) strengthen each other to make the luminescent intensity higher than in the central part of the cell C.

By the way, the PDP 38 of ALIS technology shown in FIG. 4 improves in brightness as compared with the PDP 10 shown in FIG. 1, whereas it has a higher surface reflectance ratio because of having no non-luminescence regions other than the ribs 24 and the bus electrodes 20. Specifically, while the PDP 10 having the black stripes 22 shown in FIG. 1 is lower than or equal to 20% in surface reflectance ratio, the PDP 38 of ALIS technology shown in FIG. 4 reaches 30-40% in surface reflectance ratio. Consequently, the PDP 38 of ALIS technology had a problem that the external light reflection increases to lower the bright room contrast ratio.

If the bright room contrast ratio drops, the screen of the PDP 38 looks whitish all over in bright rooms. In general, PDPs are provided with an optical filter at their front to decrease the transmittance for the sake of higher bright room contrast ratios. Simply arranging an optical filter at the front, however, lowers the brightness of the entire screen.

### SUMMARY OF THE INVENTION

It is an object of the present invention to improve the bright room contrast ratio of a plasma display panel. In particular, the object of the present invention is to improve the bright room contrast ratio of a plasma display panel of ALIS technology.

According to one of the aspects of the present invention, a plurality of discharge electrodes having transparent electrodes connected to bus electrodes are arranged on an inner side of a front substrate. The front substrate is provided on the side of the display-surface where discharge-generated light radiates out to the exterior. Shielding parts for shielding the incident light from exterior are formed on the transparent electrodes. Thus, the shielding parts reduce the surface reflection to improve the bright room contrast ratio.

According to another aspect of the present invention, a plurality of discharge electrodes having transparent electrodes, and capable of discharging between neighboring electrodes on both sides are arranged on the inner side of the front substrate. The transparent electrodes are connected to bus electrodes, respectively. That is, discharge at a discharge electrode occurs at one timing with the neighboring discharge electrode on one side, and at another timing with the discharge electrode on the other side. The front substrate is provided on the display-surface side where discharge-generated light radiates out to the exterior. Besides, shielding parts for shielding the incident light from exterior are formed along the front substrate. Therefore, even in the plasma display panel in which discharge can be made between neighboring discharge electrodes on both sides, the shielding parts reduce the surface reflection to improve the bright room contrast ratio.

When the discharge electrodes have the bus electrodes placed on the transparent electrodes as described above, the shielding parts may be formed of the same material as that of the bus electrodes. Moreover, the shielding parts may be formed integral with the bus electrodes. In this case, the shielding parts can be formed in the process of fabricating bus electrodes. That is, the bus electrodes and the shielding parts can be formed simultaneously, which prevents fabrication processes from becoming complicated. Besides, there is no need for any dedicated masks to form the shielding parts.

According to another aspect of the invention, the shielding parts are formed in conformity with portions with lower light luminescent intensities. Therefore, the bright room contrast ratio can be improved with a minimum drop in luminescent intensity.

According to another aspect of the present invention, a plurality of cells, which are units discharge-generated light is emitted in, are formed along the discharge electrodes neighboring each other. The shielding parts formed respectively in the cells have different areas depending on the luminescent colors of the cells. On this account, the brightness of cells that give off a predetermined color can be made higher than that of other cells. For example, the areas of the sheilding parts in cells emitting blue light are made smaller than those of the shielding parts in other cells emitting red light and green light, so that the brightness of the blue light relatively increases. Therefore, it is possible to increase the color temperature in displaying white while improving the bright room contrast ratio.

According to another aspect of the present invention, a rear substrate is arranged so that it faces the front substrate with a discharge space in between. A plurality of address eletrodes are parallel to each other, and placed along the rear substrate in a direction orthogonal to the discharge electrode. Ribs are formed along the spaces between the address electrodes. Then, cells, or light emission units, are formed in regions surrounded by two of the discharge electrodes neighboring each other and two of the ribs on both sides of one address electrode.

The cells each include, the transparent electrode having narrow projecting parts that project toward the center of the cell, and having opposing parts that are at the tips of the projecting parts and lie along the discharge electrodes. The shielding parts are formed on portions conforming to the portions with lower light luminescent intensities (for example, the projecting parts, portions of the opposing parts between the ribs and the centers of the opposing parts, or the sides of the bus-electrodes on the opposing parts).

According to another aspect of the present invention, a plurality of cells, which are units discharge-generated light is emitted in, are formed along the discharge electrodes neighboring each other. The cells include blue cells for emitting blue light. The shielding parts in the blue cells are formed in positions where they shield discharge-generated visible light. The shielding parts of the cells other than the blue cells are formed in conformity with portions where discharge-generated light has a low luminescent intensity. For example, external radiation produced by the blue cells, such as neon or other visible light, can be blocked to prevent a drop in color purity of the blue light while the bright room contrast ratio is improved by cells other than the blue cells.

### BRIEF DESCRIPTION OF THE DRAWINGS

The nature, principle, and utility of the invention will become more apparent form the following detailed description when read in conjunction with the accompanying drawings in which like parts are designated by identical reference numbers, in which:

FIG. 1 is a plan view showing an overview of a conventional plasma display panel of surface-discharge alternating-current type;

FIG. 2 is a cross-sectional view along the line A-A of FIG. 1;

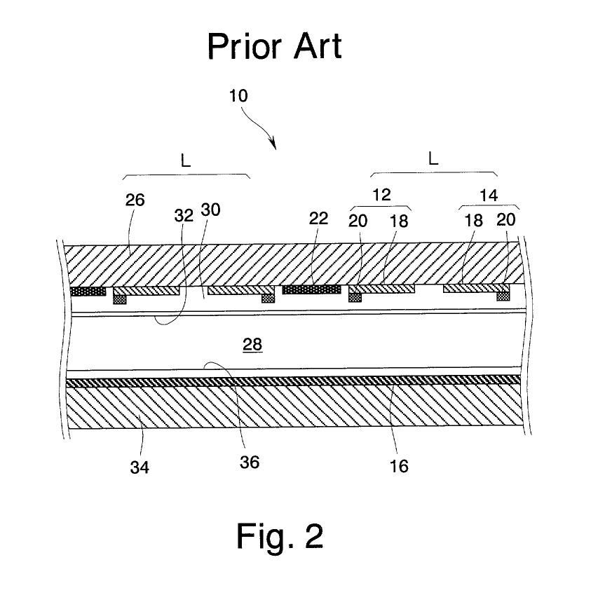

FIG. 3 is a cross-sectional view along the line B-B of FIG. 1;

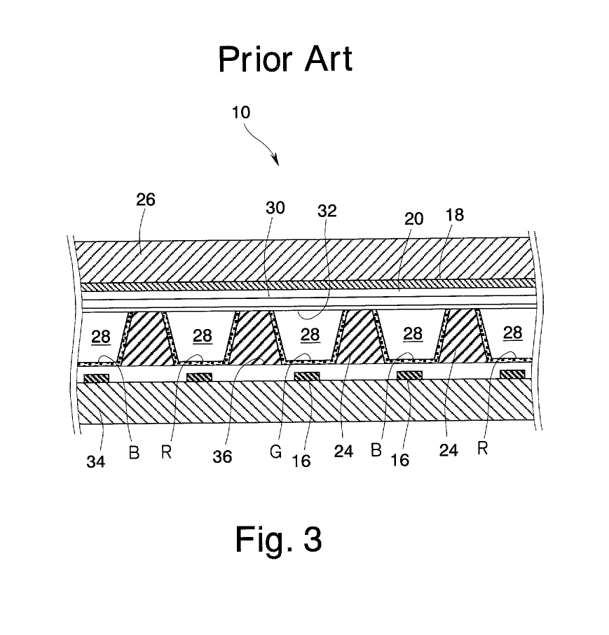

FIG. 4 is a plan view showing an overview of a conventional plasma display panel of ALIS technology;

FIG. 5 is an explanatory diagram showing a cross section along the line A-A of FIG. 4 and luminescent intensities along the cross section;

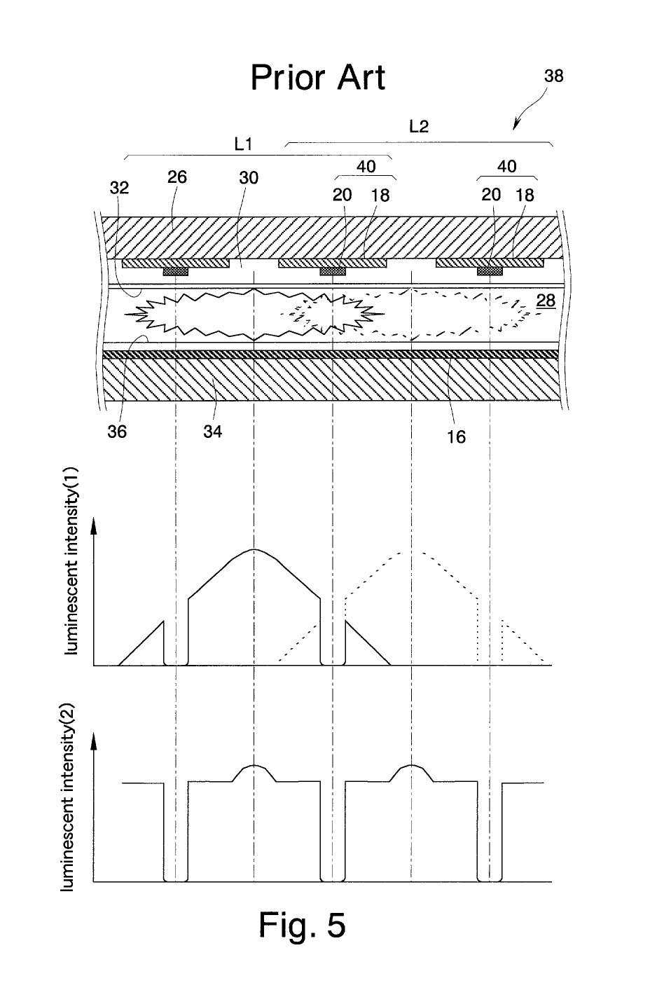

FIG. 6 is an explanatory diagram showing a cross section along the line B-B of FIG. 4 and luminescent intensities along the cross section;

FIG. 7 is a plan view showing the essential parts of a first embodiment of the plasma display panel in the present invention;

FIG. 8 is a cross-sectional view along the line B-B of FIG. 7;

FIG. 9 is an explanatory diagram showing the luminescent intensity distribution on the plasma display panel of FIG. 7;

FIG. 10 is a block diagram showing a plasma display apparatus to which the plasma display panel of FIG. 7 is applied;

FIG. 11 is a plan view showing the essential parts of a second embodiment of the plasma display panel in the present invention;

FIG. 12 is a plan view showing the essential parts of a third embodiment of the plasma display panel in the present invention;

FIG. 13 is a plan view showing the essential parts of a fourth embodiment of the plasma display panel in the present invention;

FIG. 14 is a plan view showing the essential parts of a fifth embodiment of the plasma display panel in the present invention;

FIG. 15 is a plan view showing the essential parts of a sixth embodiment of the plasma display panel in the present invention;

FIG. 16 is a plan view showing the essential parts of a seventh embodiment of the plasma display panel in the present invention; and

FIG. 17 is a plan view showing the essential parts of an eighth embodiment of the plasma display panel in the present invention.

### DESCRIPTION OF THE PREFERRED EMBODIMENTS

Hereinafter, embodiments of the present invention will be described with reference to the drawings.

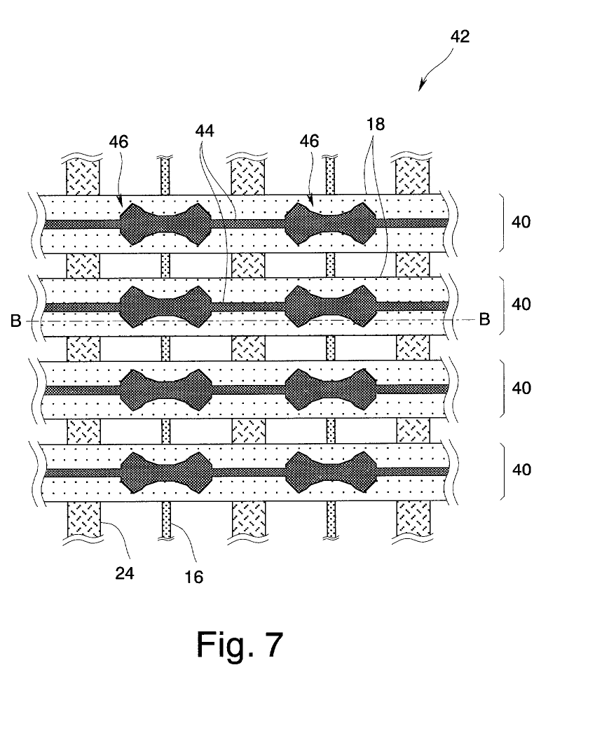

FIG. 7 shows the essential parts of a first embodiment of the plasma display panel in the present invention. The same elements as those described in the conventional art will be designated by identical reference numbers. Detailed description thereof will be omitted.

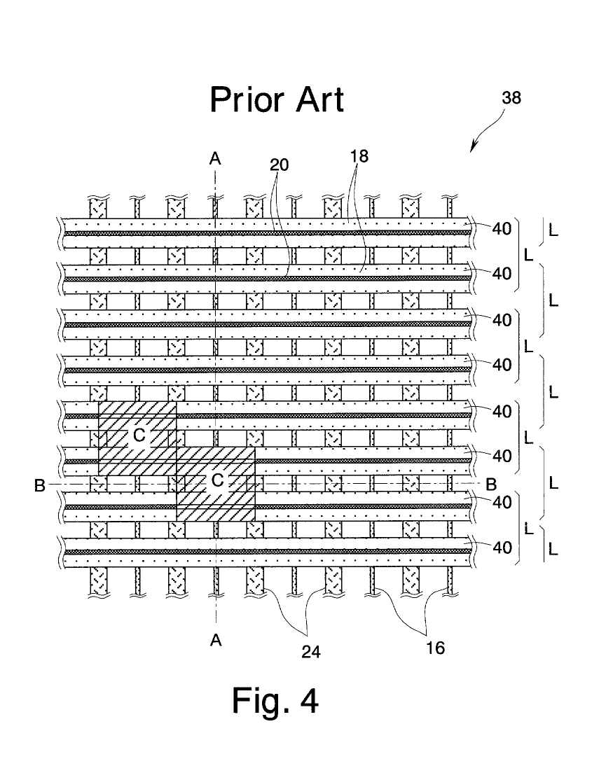

This embodiment is formed as a PDP 42 of ALIS technology, having a plurality of discharge electrodes 40 formed at regular intervals. Bus electrodes 44 constituting the discharge electrodes 40 have a configuration different from heretofore. The arrangement of transparent electrodes 18 constituting the discharge electrodes 40 and the arrangement of address electrodes 16 and ribs 24 are nearly the same as those of FIG. 4.

The bus electrodes 44 are formed broader at portions lying between the address electrodes 16 and the ribs 24, and slightly broader at portions facing the address electrodes 16. These broader portions form shielding parts 46 for shielding light incident from exterior. That is, in this embodiment, the shielding parts 46 are formed integral with the bus electrodes 44. The bus electrodes 44 have a triple-layer structure including copper (Cu) sandwiched by chrome (Cr). Since the shielding parts 46 can be formed simultaneously-with the patterning of the bus electrodes 44, the fabrication process will not become complicated. In other words, the shielding parts 46 can be formed only by changing the mask pattern of the bus electrodes 44.

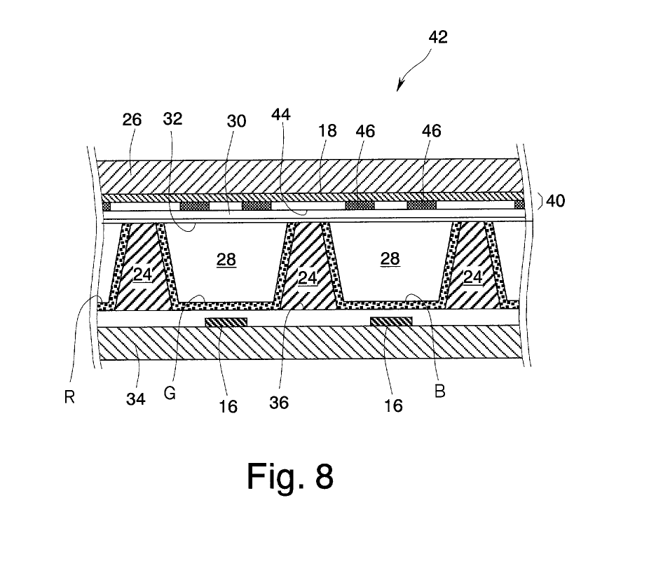

FIG. 8 shows a cross section of the PDP 42 taken along a discharge electrode 40.

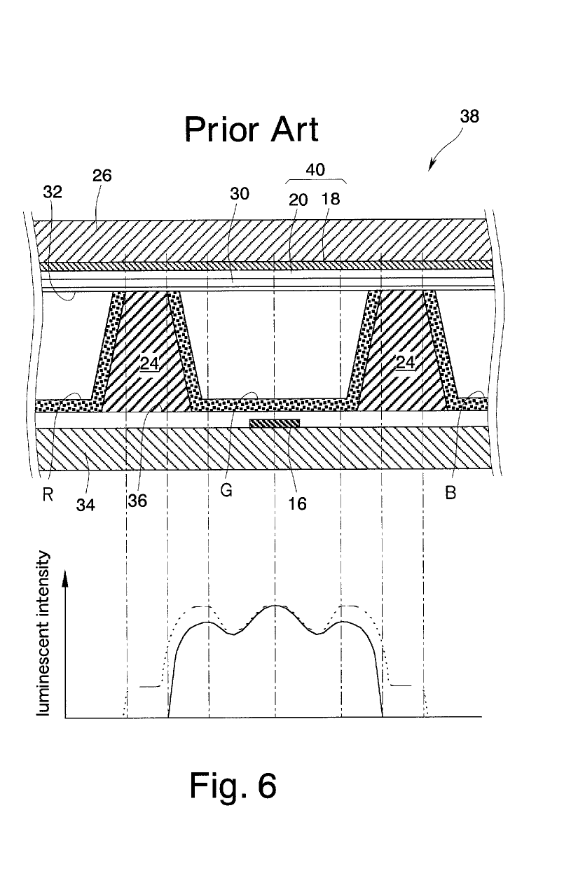

As in FIG. 6, the PDP 42 has a front substrate 26 and a rear substrate 34 which are arranged to face each other across discharge space 28. The discharge space 28 is filled with, for example, mixed gas of neon (Ne) and xenon (Xe). The transparent electrodes 18 are formed on the side with the discharge space 28 of the front substrate 26, and the shielding parts 46 (bus electrodes 44) are formed on (under, in the diagram) the transparent electrodes 18. A dielectric layer 30 and a protection layer 32 made of magnesium oxide (MgO) are formed over the discharge electrodes 40.

The address electrodes 16 are formed on the side with the discharge space 28 of the rear substrate 34. A dielectric layer 36 is formed over the address electrodes 16. The ribs 24 are formed on this dielectric layer 36. Phosphor layers R, G, and B are formed on the inclined planes of the ribs 24 and on the dielectric layer 36 surrounded by the ribs 24.

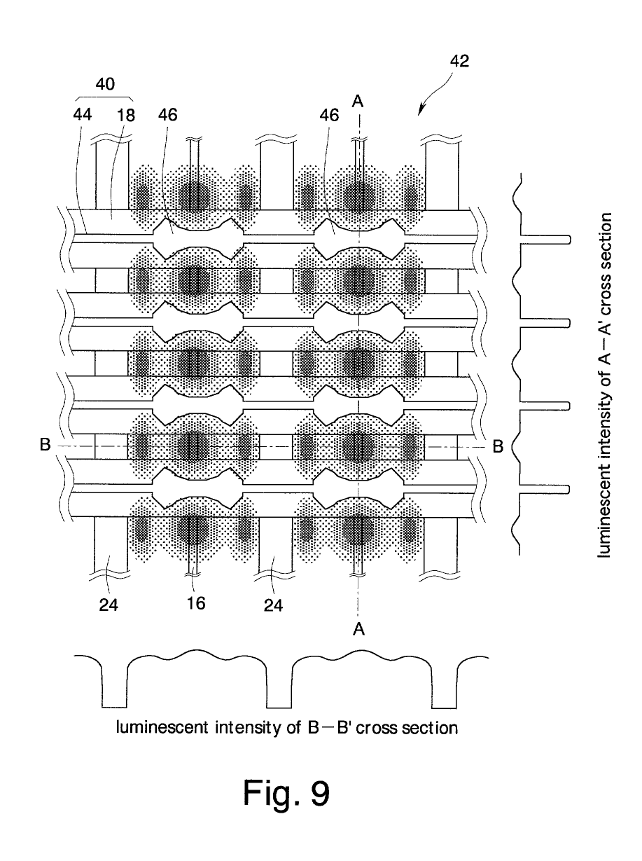

FIG. 9 shows a luminescent intensity distribution on the PDP 42 of the present embodiment.

In the diagram, darker shadows indicate portions of higher luminescent intensities. That is, the luminescent intensity on the PDP 42 is higher at portions where the transparent electrodes 18 face each other, and near the address electrodes 16 and ribs 24 in particular. The shielding parts 46 in the present embodiment are formed in conformity with the portions of lower luminescent intensities.

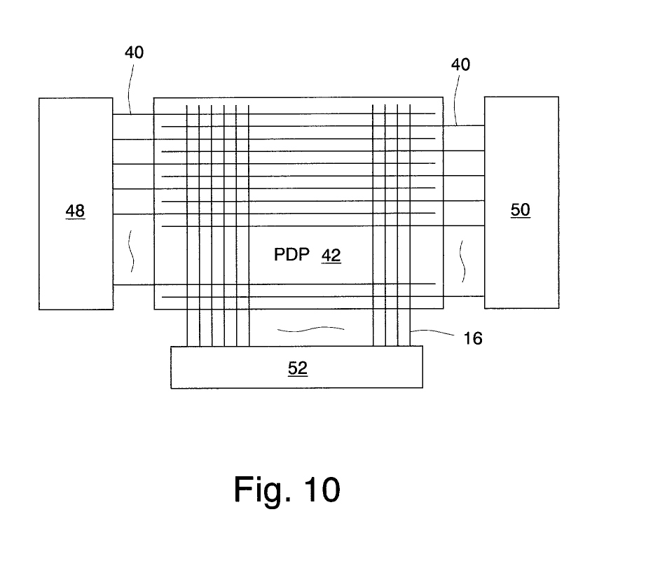

FIG. 10 shows an example of a plasma display apparatus to which the PDP 42 is applied.

The plasma display apparatus includes a first driving circuit 48 for driving odd-numbered discharge electrodes 40, a second driving circuit 50 for driving even-numbered discharge electrodes 40, and a third driving circuit 52 for driving the address electrodes 16.

As has been described, in the plasma display panel of the present embodiment, the shielding parts 46 shield some of the light incident from exterior. This allows reduction of the surface reflection for an improved bright room contrast ratio. In particular, the bright room contrast ratio can be improved in a PDP of ALIS technology in which discharge can be made with neighboring discharge electrodes on both sides.

The shielding parts 46 are formed in conformity with the portions of lower luminescent intensities. Therefore, the bright room contrast ratio can be improved with a minimum drop in luminescent brightness.

The shielding parts 46 are formed of the same material as that of the bus electrodes 44. Therefore, the shielding parts 46 can be formed simultaneously during the fabrication process of the bus electrodes 44. This prevents the fabrication process from becoming complicated. That is, the shielding parts 46 can be formed only by changing the mask pattern of the bus electrodes 44, requiring no mask dedicated to the shielding parts 46.

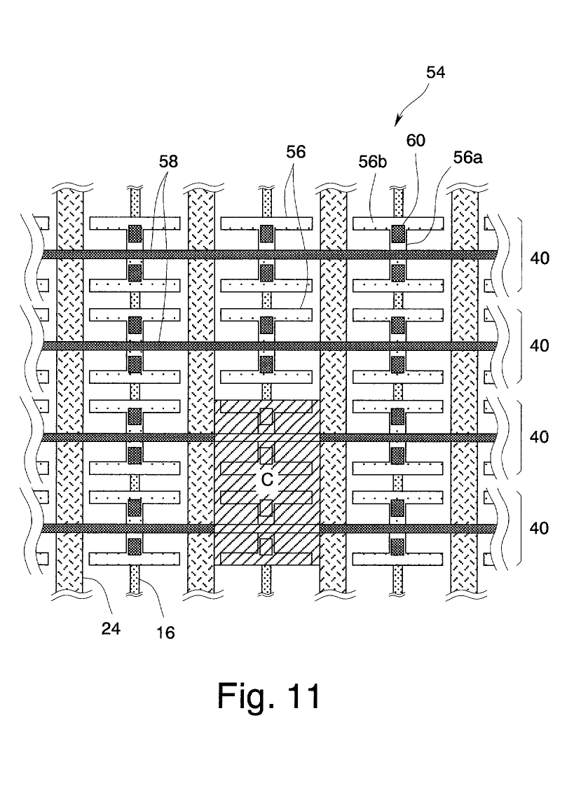

FIG. 11 shows the essential parts of a second embodiment of the plasma display panel in the present invention. The same elements as those described in the conventional art and in the first embodiment will be designated by identical reference numbers. Detailed description thereof will be omitted.

This embodiment is formed as a PDP 54 of ALIS technology, and differs from the first embodiment in the configuration of transparent electrodes 56 and in the configuration of bus electrodes 58. The other structure is almost identical to that of the first embodiment.

The transparent electrodes 56 that constitute the discharge electrodes 40 are formed in the same width as that of the bus electrodes 58. In the individual cells C, the transparent electrodes 56 have narrow projecting parts 56a which project toward the centers of the cells C. Opposing parts 56b lying along the bus electrodes 58 are formed integrally on the tips of the projecting parts 56a. That is, the transparent electrodes 56 in the individual cells C are formed in T-shapes facing each other. The T-shape formation of the transparent electrodes 56 reduces the areas of the discharge electrodes 40, and thereby avoids an increase in the discharge current. This consequently avoids a drop in luminous efficiency.

Besides, widening the opposing parts of the transparent electrodes 56 prevents a rise in discharge starting voltage.

Shielding parts 60 are formed on the transparent electrodes 56, at the sides with the opposing part 56b of the projecting parts 56a by using the same material as that of the bus electrode 58. The shielding parts 60 are formed at positions of lower luminescent intensities. That is, the shielding parts 60 are formed away from the regions with high luminescent intensity where the opposing parts 56b face each other.

This embodiment can offer the same effects as those obtained from the first embodiment described above. Moreover, according to this embodiment, even the PDP 54 with low power consumption and reduced with discharge current can be improved in bright room contrast ratio with a minimum drop in luminescent brightness.

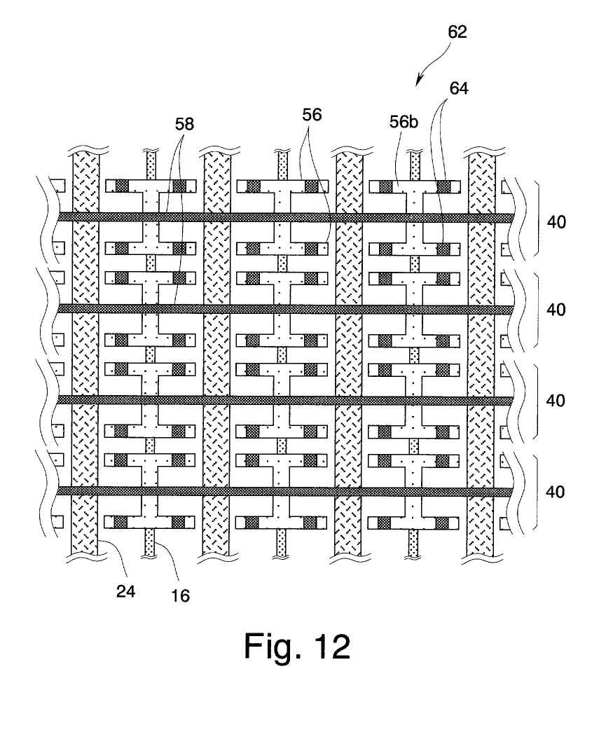

FIG. 12 shows the essential parts of a third embodiment of the plasma display panel in the present invention. The same elements as those described in the conventional art and in the second embodiment will be designated by identical reference numbers. Detailed description thereof will be omitted.

This embodiment is formed as a PDP 62 of ALIS technology, and differs from the second embodiment in the configuration and arranged positions of shielding parts 64. The other structure is identical to that of the second embodiment. The shielding parts 64 are formed on the opposing parts 56b, between the centers of the opposing parts 56b and the ribs 24. That is, the shielding parts 64 are formed away from the regions with high luminescent intensity, where the opposing parts 56b face each other.

This embodiment can offer the same effects as those obtained from the second embodiment described above.

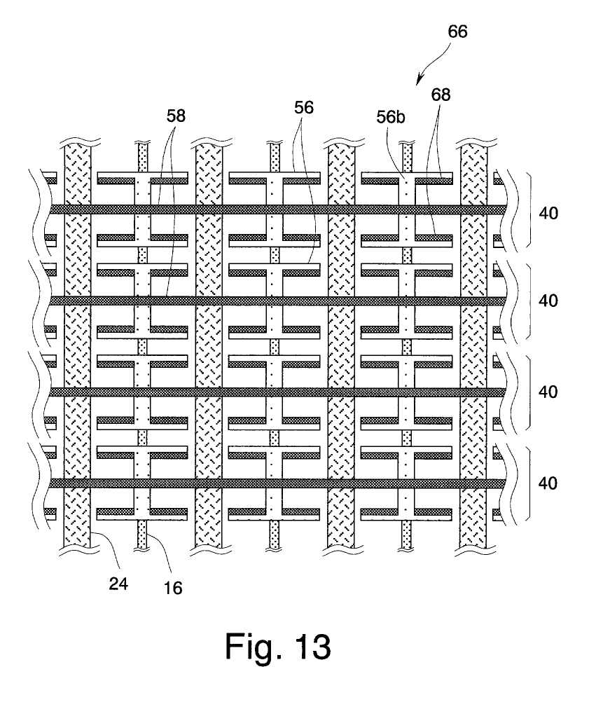

FIG. 13 shows the essential parts of a fourth embodiment of the plasma display panel in the present invention. The same elements as those described in the conventional art and in the second embodiment will be designated by identical reference numbers. Detailed description thereof will be omitted.

This embodiment is formed as a PDP 66 of ALIS technology, and differs from the second embodiment in the configuration and arranged positions of shielding parts 68. The other structure is identical to that of the second embodiment. The shielding parts 68 are formed on the sides with the bus electrode 58 of the opposing parts 56b. That is, the shielding parts 68 are formed at positions away from the regions with high luminescent intensity, where the opposing parts 56b face each other.

This embodiment can offer the same effects as those obtained from the second embodiment described above.

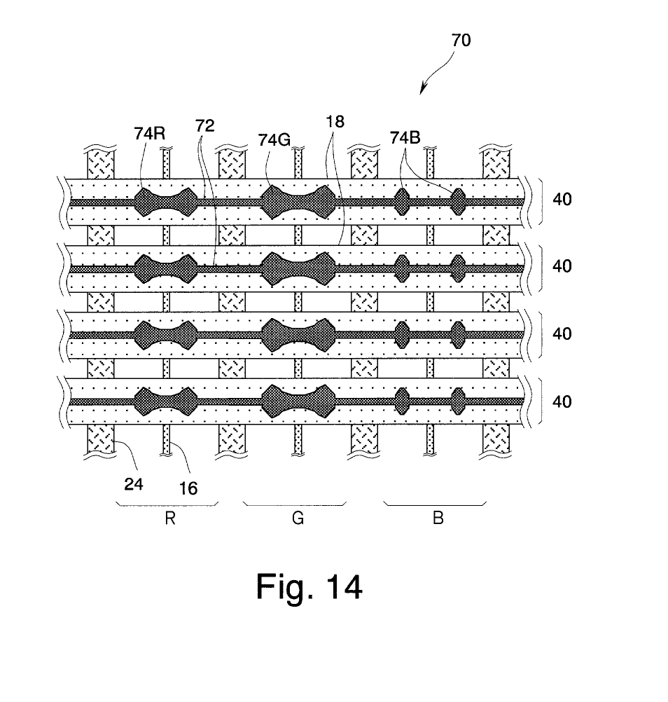

FIG. 14 shows the essential parts of a fifth embodiment of the plasma display panel in the present invention. The same elements as those described in the conventional art and in the first embodiment will be designated by identical reference numbers. Detailed description thereof will be omitted.

This embodiment is formed as a PDP 70 of ALIS technology. In this PDP 70, shielding parts 74R, 74G, and 74B formed integrally on bus electrodes 72 have different shapes depending on the luminescent colors of the cells C. The other structure is identical to that of the first embodiment. The shielding parts 74B formed in cells C that have a phosphor layer B for emitting blue light are formed smaller than the shielding parts 74R formed in cells C that have a phosphor layer R for emitting red light. The shielding parts 74R are formed smaller than the shielding parts 74G formed in cells C that have a phosphor layer G for emitting green light. That is, the increasing order of the areas of the shielding parts is the shielding parts 74B, the shielding parts 74R, and the shielding parts 74G.

Reducing the shielding parts 74B in area makes the blue light relatively higher in brightness. This allows an increase of the color temperature in displaying white. Here, the bright room contrast ratio is improved by the shielding parts 74G and 74R of relatively greater areas. The shielding parts 74R, 74G, and 74B are formed in positions of lower luminescent intensities. Therefore, the formation of these shielding parts 74R, 74G, and 74B causes a minimum drop in brightness.

This embodiment can offer the same effects as those obtained from the first embodiment described above. Moreover, in this embodiment, the areas of the shielding parts 74B in cells C emitting blue light are made smaller than the areas of the shielding parts 74R and 74G in cells C emitting red and green light. This can make the blue light relatively higher in brightness. Accordingly, it is possible to increase the white-displaying color temperature while improving the bright room contrast ratio.

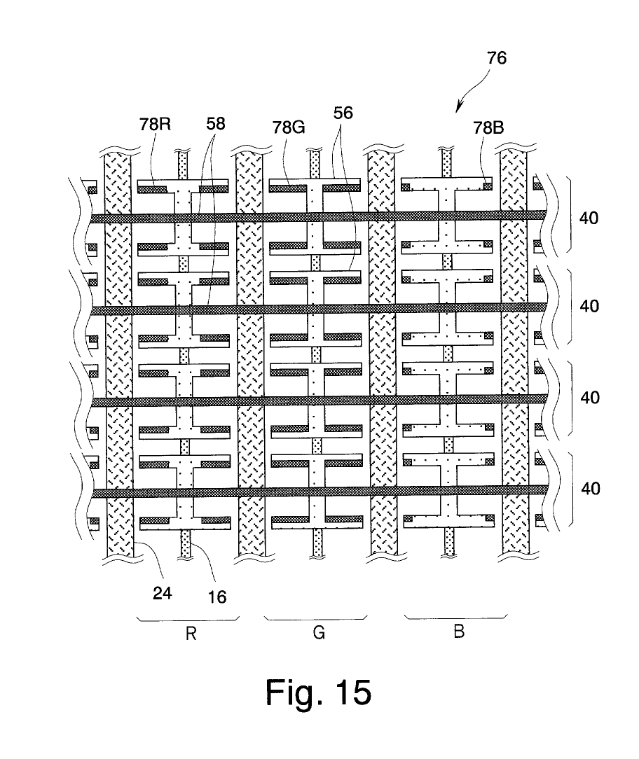

FIG. 15 shows the essential parts of a sixth embodiment of the plasma display panel in the present invention. The same elements as those described in the conventional art and in the fourth embodiment will be designated by identical reference numbers. Detailed description thereof will be omitted.

This embodiment is formed as a PDP 76 of ALIS technology having the T-shaped transparent electrodes 56, in which shielding parts 78R, 78G, and 78R have different areas depending the luminescent colors of the cells C. The other structure is identical to that of the fourth embodiment. As in the fifth embodiment, the increasing order of the areas of the shielding parts is the shielding parts 78B formed in the cells C having the phosphor layer B, the shielding parts 78R formed in the cells C having the phosphor layer R, and the shielding parts 78G formed in the cells C having the phosphor layer G. The shielding parts 78R, 78G, and 78B are formed in positions of lower luminescent brightness, thereby minimizing the drop in brightness.

This embodiment can offer the same effects as those obtained from the fifth embodiment described above.

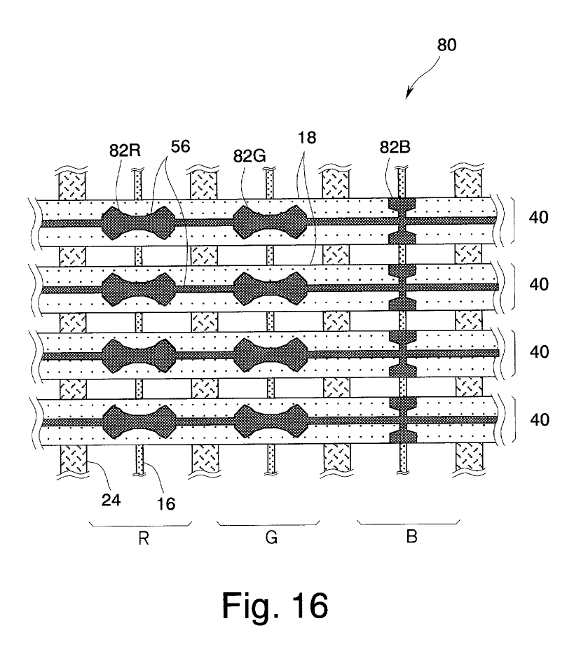

FIG. 16 shows the essential parts of a seventh embodiment of the plasma display panel in the present invention. The same elements as those described in the conventional art and in the first embodiment will be designated by identical reference numbers. Detailed description thereof will be omitted.

This embodiment is formed as a PDP 80 of ALIS technology. Shielding parts 82R formed in the cells C that have the phosphor layer R and shielding parts 82G formed in the cells C that have the phosphor layer G are formed in the same shapes and positions as those of the shielding parts 46 in the first embodiment described above while shielding parts 82B formed in the cells C that have the phosphor layer B are formed in conformity with discharging portions. That is, the shielding parts 82B are formed in conformity with portions of higher luminescent brightness. In general, when the gas in the discharge space 28 contains neon (Ne), discharging portions produce not only ultraviolet rays but also visible light resulting from neon discharge. In the cells that emit blue light, this visible light makes the blue light look reddish, with a drop in blue color purity. The formation of the shielding parts 82B in conformity with discharging portions in the cells emitting blue light prevents the external radiation of the visible light caused by neon discharge, thereby avoiding the drop in blue color purity. Here, the bright room contrast ratio is improved by the shielding parts 82G and 82R of relatively greater areas.

This embodiment can offer the same effects as those obtained from the second embodiment described above. Moreover, in this embodiment, the shielding parts 82b in the cells emitting blue light block the external radiation of the visible light caused by neon discharge and the like. This can avoid a drop in the color purity of the blue light.

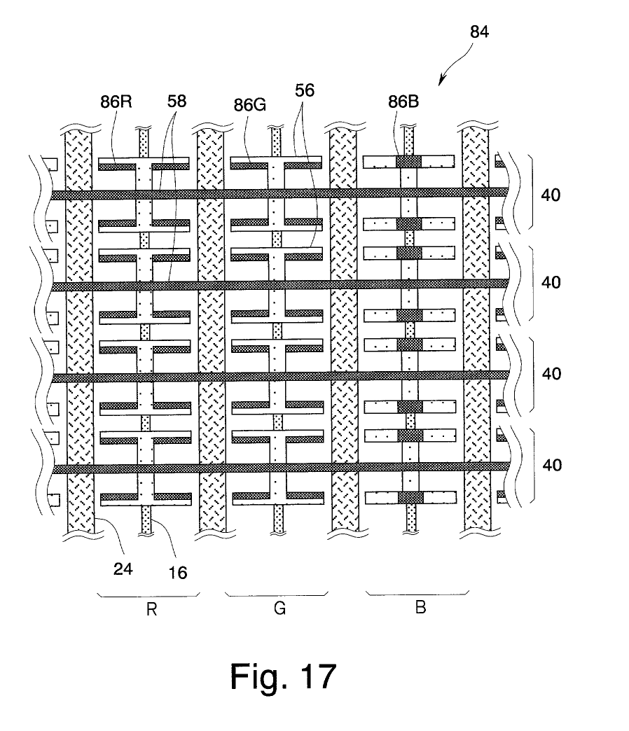

FIG. 17 shows the essential parts of an eighth embodiment of the plasma display panel in the present invention. The same elements as those described in the conventional art and in the fourth embodiment will be designated by identical reference numbers. Detailed description thereof will be omitted.

This embodiment is formed as a PDP 84 of ALIS technology. Shielding parts 86R formed in the cells C that have the phosphor layer R and shielding parts 86G formed in the cells C that have the phosphor layer G are formed in the same sizes and positions as those of the shielding parts 68 in the fourth embodiment described above while shielding parts 86B formed in the cells C that have the phosphor layer B are formed in conformity with discharging portions. That is, the shielding parts 86B are formed in conformity with portions of higher luminescent brightness, thereby avoiding the external radiation of the visible light caused by neon discharge.

This embodiment can offer the same effects as those obtained from the seventh embodiment described above.

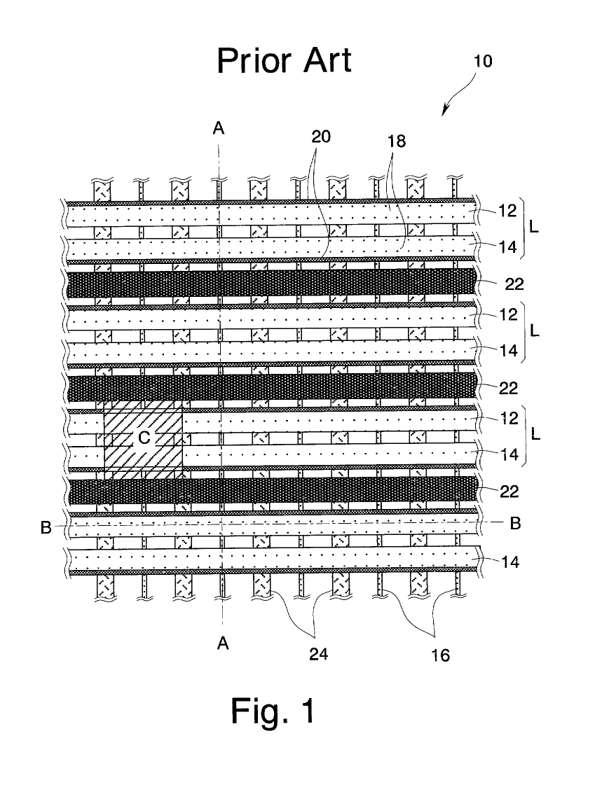

Now, the embodiments described above have dealt with the cases where the present invention is applied to a PDP of ALIS technology. However, the present invention is not limited to such embodiments. For example, the present invention may be applied to a PDP in which sustain discharge is created between a pair of discharge electrodes alone (such as a PDP having the black stripe 22 shown in FIG. 1).

The second embodiment described above has dealt with the case where the shielding parts 60 are formed apart from the bus electrodes 58. However, the present invention is not limited to such an embodiment. For example, the shielding parts may be formed integral with the bus electrodes 58.

The second embodiment described above has dealt with the case where the shielding parts are formed of the same material as that of the bus electrodes. However, the present invention is not limited to such an embodiment. For example, the shielding parts may be formed of material different from that of the bus electrodes. Here, insulators may be used to form the shielding parts on portions other than where they face the transparent electrodes.

The invention is not limited to the above embodiments and various modifications may be made without departing from the spirit and scope of the invention. Any improvement may be made in part or all of the components.

What is claimed is:

1. A plasma display panel comprising:
a plurality of discharge electrodes arranged on an inner side of a front substrate provided on a side of a display surface, each of said discharge electrodes having a bus electrode and a transparent electrode connected to said bus electrode; and
shielding parts formed on said transparent electrode to shield incident light from exterior.

2. The plasma display panel according to claim 1, wherein said shielding parts are formed in conformity with portions where discharge-generated light has a low luminescent intensity.

3. The plasma display panel according to claim 2, comprising:
a rear substrate facing said front substrate, with a discharge space in between;
a plurality of address electrodes parallel to each other, and placed along said rear substrate in a direction orthogonal to said discharge electrodes;
ribs formed along spaces between said address electrodes; and
cells, which are units discharge-generated light are emitted in, are formed in regions each surrounded by said discharge electrodes neighboring each other and said ribs on both sides of one said address electrode, wherein
said cells each include said transparent electrode having a narrow projecting part projecting toward the center of the cell, and having opposing parts at a tip of said projecting part, lying along said discharge electrodes.

4. The plasma display panel according to claim 3, wherein said shielding parts are formed on said projecting parts.

5. The plasma display panel according to claim 3, wherein said shielding parts are formed on said opposing parts, each of the shielding parts formed between said rib and the center of said opposing part.

6. The plasma display panel according to claim 3, wherein said shielding parts are formed on said opposing parts, at the sides closer to said bus electrodes.

7. The plasma display panel according to claim 1, wherein said shielding parts are formed of the same material as that of said bus electrodes.

8. The plasma display panel according to claim 7, wherein said shielding parts are formed integral with said bus electrodes.

9. The plasma display panel according to claim 1, wherein:
a plurality of cells, which are units discharge-generated light is emitted in, are formed along said discharge electrodes neighboring each other; and
said shielding parts formed respectively in said cells have different areas depending on the luminescent colors of said cells.

10. The plasma display panel according to claim 9, wherein:
said cells include blue cells for emitting blue light; and
said shielding part formed in each of said blue cells have an area smaller than areas of said shielding parts formed in other cells.

11. The plasma display panel according to claim 1, wherein:
a plurality of cells, which are units discharge-generated light is emitted in, are formed along said discharge electrodes neighboring each other; and
said cells include blue cells for emitting blue light;
said shielding part in each of said blue cells is formed in a position where it blocks discharge-generated visible light from radiating out to said exterior; and
said shielding parts in said cells other than said blue cells are formed in conformity with portions where discharge-generated light has a low luminescent intensity.

12. A plasma display panel comprising:
a plurality of discharge electrodes arranged on an inner side of a front substrate provided on a side of a display surface, each of said discharge electrodes having a bus electrode and a transparent electrode connected to said bus electrode, said discharge electrodes capable of discharging between neighboring electrodes on both sides; and
shielding parts formed along said front substrate to shield incident light from exterior.

13. The plasma display panel according to claim 12, wherein said shielding parts are formed in conformity with portions where discharge-generated light has a low luminescent intensity.

14. The plasma display panel according to claim 13, comprising:
a rear substrate facing said front substrate, with a discharge space in between;
a plurality of address electrodes parallel to each other, and placed along said rear substrate in a direction orthogonal to said discharge electrodes;
ribs formed along spaces between said address electrodes; and
cells, which are units discharge-generated light are emitted in, are formed in regions each surrounded by said discharge electrodes neighboring each other and said ribs on both sides of one said address electrode, wherein
said cells each include said transparent electrode having a narrow projecting part projecting toward the center of the cell, and having opposing parts at a tip of said projecting part, lying along said discharge electrodes.

15. The plasma display panel according to claim 14, wherein said shielding parts are formed on said projecting parts.

16. The plasma display panel according to claim 14, wherein said shielding parts are formed on said opposing parts, each of the shielding parts formed between said rib and the center of said opposing part.

17. The plasma display panel according to claim 14, wherein said shielding parts are formed on said opposing parts, at the sides closer to said bus electrodes.

18. The plasma display panel according to claim 12, wherein said shielding parts are formed of the same material as that of said bus electrodes.

19. The plasma display panel according to claim 18, wherein said shielding parts are formed integral with said bus electrodes.

20. The plasma display panel according to claim 12, wherein:
a plurality of cells, which are units discharge-generated light is emitted in, are formed along said discharge electrodes neighboring each other; and
said shielding parts formed respectively in said cells have different areas depending on the luminescent colors of said cells.

21. The plasma display panel according to claim 20, wherein:
said cells include blue cells for emitting blue light; and
said shielding part formed in each of said blue cells have an area smaller than areas of said shielding parts formed in other cells.

22. The plasma display panel according to claim 12, wherein:
a plurality of cells, which are units discharge-generated light is emitted in, are formed along said discharge electrodes neighboring each other; and
said cells include blue cells for emitting blue light;
said shielding part in each of said blue cells is formed in a position where it blocks discharge-generated visible light from radiating out to said exterior; and
said shielding parts in said cells other than said blue cells are formed in conformity with portions where discharge-generated light has a low luminescent intensity.
